(19) United States
(12) Patent Application Publication
(10) Pub. No.: US 2024/0393482 A1
(43) Pub. Date: Nov. 28, 2024

(54) HYBRID MESH FOR MICROMEGAS DETECTOR

(71) Applicant: JEFFERSON SCIENCE ASSOCIATES, LLC, NEWPORT NEWS, VA (US)

(72) Inventors: BOGDAN WOJTSEKHOWSKI, YORKTOWN, VA (US); NILANGA LIYANAGE, CHARLOTTESVILLE, VA (US); XINZHAN BAI, CHARLOTTESVILLE, VA (US)

(21) Appl. No.: 18/661,995

(22) Filed: May 13, 2024

Related U.S. Application Data
(60) Provisional application No. 63/469,369, filed on May 27, 2023.

(51) Int. Cl. G01T 1/185; G01T 1/29

(52) U.S. Cl. CPC G01T 1/185; G01T 1/2935

(57) ABSTRACT

A hybrid mesh for a micromegas particle detector is proposed. The mesh consists of metal wires strung in one direction and non-conductive wires strung in a second direction. Avoiding electrical contact between the metal wires solves the problem of high energy sparking which is the main complication of the micromegas detectors. The insulation between the metal wires also improves the reconstruction accuracy for the track coordinate readout.

This application claims the priority of Provisional U.S. Patent Application Ser. No. 63/469,369 filed May 27, 2023.

The United States Government may have certain rights to this invention under Management and Operating Contract No. DE-AC05-06OR23177 from the Department of Energy.

### FIELD OF THE INVENTION

The present invention relates to tracking detectors for charged particles, typically used in experimental research in nuclear and particle physics, high energy physics, and also industries such as medical and safety scanners. More particularly, this invention relates to a Micromegas device for determining the positions of charged particles that are used to reconstruct particle tracks.

### BACKGROUND OF THE INVENTION

Particle tracking in nuclear and particle physics experiments is of exceptional importance, as it lays down the foundation for momentum reconstruction, vertex reconstruction, PID, etc. One of the most advanced technologies for particle tracking is Micro Pattern Gaseous Detectors, particularly due to their exceptionally low material budget, high position resolution, large area, and versatility to fit different shapes; Micromegas detectors belong to this type. Modern experiments usually require a position resolution of less than 100 micrometers and, most importantly, years-long continuous operation without detector breakdown.

Conventional metal-mesh Micromegas detectors have a limit of stable operation at high radiation intensity. This limitation lies at the very core of their operational principle. In order to maintain a reasonable signal gain, Micromegas detectors require a high electric field region for electron number multiplication-gain; this is usually achieved by constructing a very narrow amplification area, typically 100˜200 micrometers thick, with a high voltage gradient. Since the total number of primary electrons follows a Poisson nature, eventually there will be events with a very large number of total electrons causing a spark in the amplification region.

High energy sparking leads to fast aging of the detector and significant dead time. In the worst case scenario, the damage to the detector can be irreparable. Typical solutions for resolving the sparking issue include stacking multiple layers of the amplification region and reducing the effective gain on each layer by lowering the high voltage, at the cost of introducing additional multiple scattering materials.

A solution for sparking without adding additional multiple scattering materials would have a wide range of applications, especially in nuclear physics research involving high beam intensities as well as in medical applications.

### BRIEF SUMMARY OF THE INVENTION

The invention is a hybrid mesh for Micromegas detectors. The hybrid mesh includes metal wires and non-conductive wires. The metal wires are oriented in one direction (e.g. X), and the non-conductive wires are oriented in a second direction (e.g. Y). Compared with traditional metal mesh, this invention eliminates the electrical contact within the metal wire set. When the metal wires in one direction are replaced by non-conductive wires, the capacitance which is discharged in the possible spark is reduced drastically, therefore the problem of damage by sparking is resolved.

The sparking in Micromegas detectors is a discharge with the stored energy accumulated in the amplification region, and the stored energy is a product of the capacitance and the square of the high voltage between the mesh and the anode. Compared to traditional metal mesh, this invention replaced metal wires in one direction with non-conductive wires, leading to decoupling the wires and drastically lowering the capacitance dischargeable in one spark. As a result, the stored energy is reduced. Additionally, the coordinate of the track could be found by detecting the wire which has a signal.

### OBJECTS AND ADVANTAGES

A first objective of the invention is to solve the sparking problem in Micromegas detectors, which leads to fast aging of the detectors and significant dead time.

A second objective of the invention is to provide a low material budget Micromegas detector that is immune to sparking. Other solutions on the market to resolve sparking include adding extra amplification layers to reduce the high voltage applied to each layer while maintaining a similar total gain, at the cost of increasing multiple scattering of the traversing particles. Another solution to resolve sparking includes division of the mesh plane into a large number of small area zones which vastly increases the amount of material and complexity of the detector construction.

Another objective of the invention is to improve the track reconstruction accuracy, as the present invention does not require extra amplification layers, which are a major cause of multiple scattering.

These and further objectives and advantages will become clear when reading the following specifications along with reference to the associated drawings.

### BRIEF DESCRIPTION OF THE SEVERAL VIEWS OF THE DRAWING(S)

Reference is made herein to the accompanying drawings, which are not necessarily drawn to scale, and wherein:

FIG. 1 is a top view of the hybrid mesh.

FIG. 2 is an isometric view of the hybrid mesh showing the woven feature.

FIG. 3 is a zoomed-in detail view of a portion of the mesh highlighted in FIG. 2.

FIG. 4 is an isometric view of a Micromegas detector with the hybrid mesh installed on a holding frame as one of its key components.

FIG. 5 is a side view of the Micromegas detector.

### DETAILED DESCRIPTION OF THE INVENTION

The invention is a hybrid mesh for Micromegas detectors. The hybrid mesh includes metal wires and non-conductive wires. The metal wires are oriented in one direction (e.g. X), and the non-conductive wires are oriented in a second direction (e.g. Y). Compared with traditional Micromegas detectors, which are constructed strictly of metal mesh, the hybrid mesh of the current invention eliminates the electrical contact between wires. With metal wires in one direction replaced by non-conductive wires, the capacitance discharge involved in one spark is reduced, drastically reducing the energy of discharge.

In operation, the mesh and the anode constructs a capacitor, and a high voltage is applied across the mesh and the anode to form a strong electric field. Sparking is essentially a discharge of the energy stored within the capacitor, which is proportional to the product of the capacitance and the square of the high voltage. The hybrid mesh of the current invention resolves the sparking problem by reducing the capacitance dischargeable in one spark while maintaining the same or even higher voltage, therefore maintaining a similar signal gain. Additionally, this invention resolves the sparking without adding additional amplification layers which contribute to the multiple scattering, therefore enhancing the track coordinate readout.

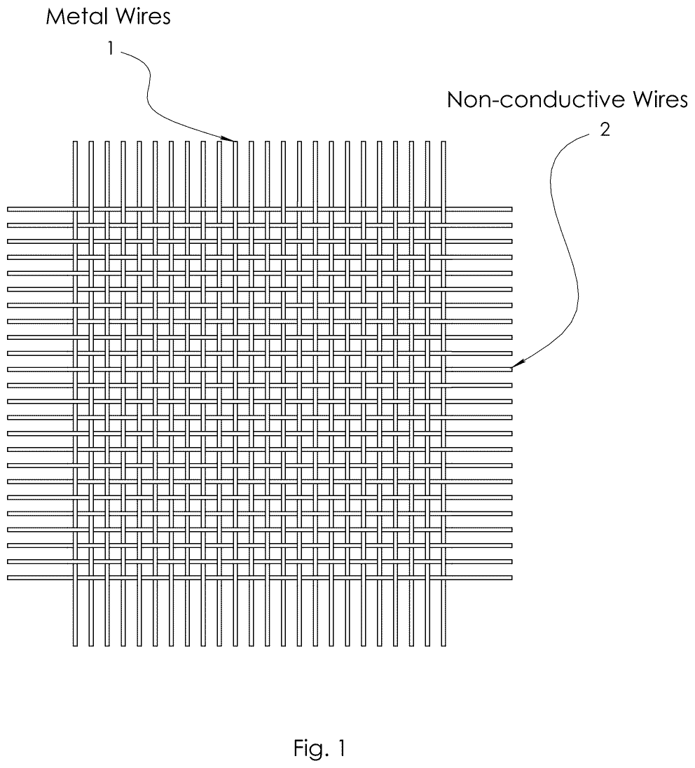

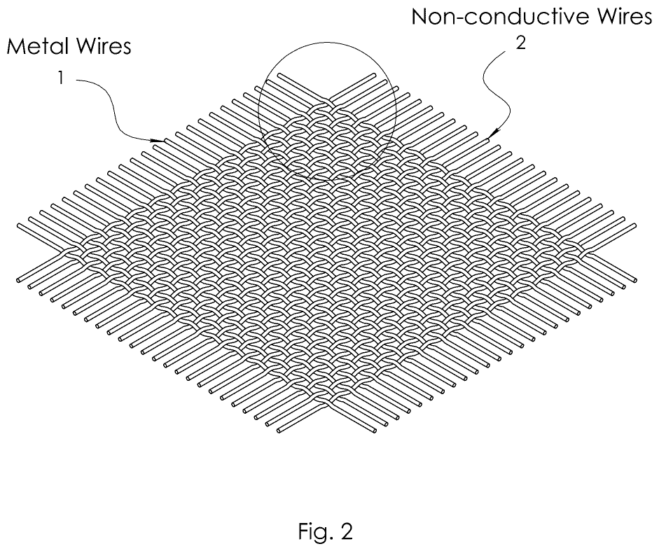

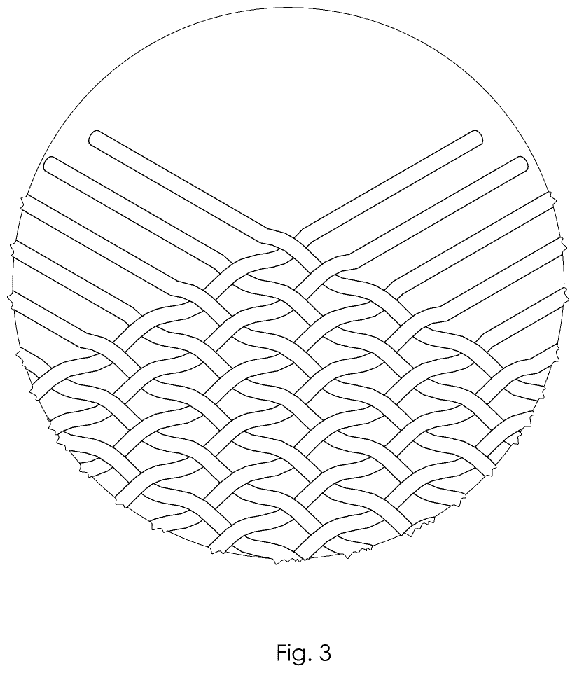

With reference to FIGS. 1-3, the hybrid mesh includes two sets of wires, the metal wires 1 (see FIG. 1) strung in one direction and the non-conductive wires 2 strung perpendicular to the metal wires. The two sets of wires are manufactured in a woven structure to maintain the contact between the two sets of wires. An isometric view is given in FIG. 2 to show the woven feature of the mesh, and a zoomed-in view of the woven mesh is given in FIG. 3. Preferably, the metal wires and the non-metallic wires have a diameter of 5-20 μm.

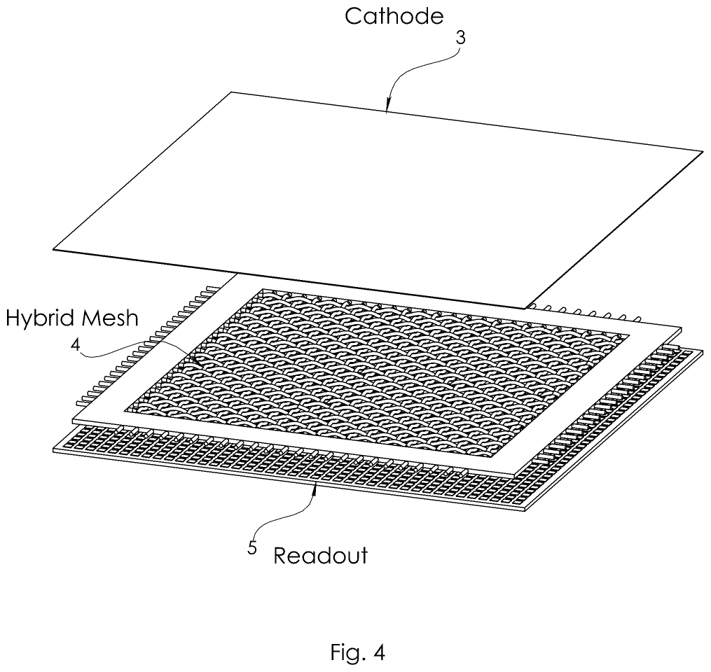

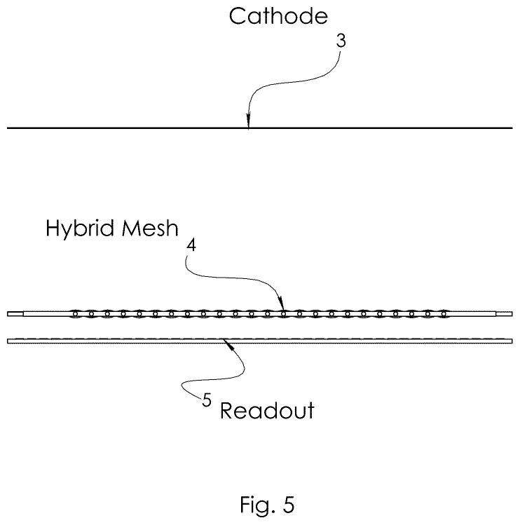

With reference to FIGS. 4-5, a typical Micromegas detector using the hybrid mesh is depicted. The Micromegas detector consists of a cathode layer 3 (see FIG. 4) which is typically made of a thin layer of metal, a hybrid mesh 4 installed on a frame, and a readout board 5 right under the mesh. The readout board consists of readout strips or pads, which are preferably fabricated using commercial lithography technology.

As depicted in FIG. 5, the distance between the cathode layer and the mesh is preferably larger than the distance between the mesh and the anode. The distance between the cathode layer and the mesh spans a few millimeters to several centimeters (3-30 mm) depending on their usages, the distance between the mesh and the anode preferably spans 100-200 micrometers. In operation, the anode is connected to the ground potential, while the mesh and the cathode are connected to high negative voltages. The purpose of this arrangement is to form a strong electric field in the region between the mesh and the anode, serving as the amplification region, and the electrons that proliferate in the amplification region are collected by the readout strips/pads, which are then processed by dedicated application-specific integrated circuits (ASICs).

The two sets of wires need not be perpendicular, and the resulting hybrid mesh is not constrained to be in square shape. Additionally, the pitch between wires is also versatile as needed. Any and all such modifications are intended to be included within the scope of the appended claims.

What is claimed is:

1. A tracking detector for charged particles with reduced high energy sparking and improved reconstruction accuracy, comprising:
a cathode;
a hybrid mesh;
an anode; and
a readout board.

2. The detector of claim 1 wherein said hybrid mesh comprises:
a set of metal wires strung in a first direction; and
a set of non-conductive wires strung in a second direction.

3. The detector of claim 2 comprising said set of metal wires in a first direction are perpendicular to said set of non-conductive wires.

4. The detector of claim 3 comprising said metal wires and said non-metallic wires include a diameter of 5-20 μm.

5. The detector of claim 3 comprising said metal wires and said non-metallic wires are in a woven structure to maintain the position of the metal wires.

6. The detector of claim 1 comprising said cathode and said hybrid mesh are separated by a distance of 3-30 mm.

7. The detector of claim 6 comprising said hybrid mesh and said readout board are separated by a distance of less than 100-200 μm.

8. The detector of claim 5 comprising said readout board comprises a plurality of readout strips.

9. The detector of claim 8 comprising said woven structure providing insulation between the metal wires thereby improving the reconstruction accuracy for a track coordinate readout.

10. The detector of claim 9 comprising:
each of said metal wires connected to one of said readout strips;
each of said metal wires providing an electrical signal and a position to its readout strip; and
said track coordinate readout is constructed from said electrical signals and positions of the metal wires.
